(19) United States
(12) Patent Application Publication
(10) Pub. No.: US 2021/0086199 A1
(43) Pub. Date: Mar. 25, 2021

(54) USE OF NON OXIDANT BIOCIDE FOR THE SELECTIVE RECOVERY OF VALUABLE METALS IN A FROTH FLOTATION PROCESS

(71) Applicant: DDP SPECIALTY ELECTRONIC MATERIALS US, INC., COLLEGEVILLE, PA (US)

(72) Inventor: Matheus P. Pashoalino, Sao Paulo (BR)

(21) Appl. No.: 16/633,774

(22) PCT Filed: Jun. 15, 2018
(86) PCT No.: PCT/US2018/037692

§ 371 Date: Jan. 24, 2020

Related U.S. Application Data
(60) Provisional application No. 62/538,046, filed on Jul. 28, 2017.

(51) Int. Cl. B03D 1/08; A01N 37/34

(52) U.S. Cl. CPC B03D 1/085; B03D 2203/025; B03D 2203/04; A01N 37/34

(57) ABSTRACT

The present invention relates to a method for the selective recovery of valuable metal minerals in a froth floatation process using a non-oxidizing biocide.

The present invention relates to a method for the selective recovery of valuable metals in a froth floatation process.

Froth flotation is used for the separation of a wide variety of valuable minerals. While the process is efficient, it uses large quantities of water. As mining operations strive to become more environment friendly, there is a continued push to reduce freshwater extraction and increase water reuse. Quality variation of reused water, however, may impact flotation efficiency. The factors related to water quality that affect flotation can be abiotic (chemical residuals) or biotic (microorganisms), and the effects can be negative or positive. Positive effects of bacterial presence on mine extraction are related to bioleaching of valuable minerals, generally adding specific cultures of previous isolated species.

Indigenous or water-borne bacteria can also have negative effect on flotation process. Oxidizing biocides have been proposed to reduce bacterial impact on flotation process. Sodium hypochlorite is one example in the art that was found effective in improving flotation of apatite ores.

U.S. Pat. No. 4,997,550 discloses the use of non-oxidizing biocides, e.g. tetrahydrothiadiazine thiones and 1,2-benzisothiozolin-3-one to improve brightness of kaolin clays. Higher brightness of kaolin clay was the result of improved flotation (removal) of titaniferous impurities. While kaolin recovery is the focus of U.S. Pat. No. 4,997,550 a need exists for a process in the mining industry for recovering copper and other valuable metals more efficiently.

The present invention solves this problem by providing a process to recover a metal of value from an aqueous pulp, comprising contacting an aqueous pulp with a biocide, wherein the aqueous pulp comprises a metal ore; and, thereafter recovering the metal of value by subjecting the aqueous pulp to froth flotation.

All percentages and ppm values are on the basis of total weight of the composition, unless otherwise indicated. The terms “a” or “an” refer both to the singular case and the case where more than one exists. All range endpoints are inclusive and combinable. It is envisioned that one skilled in the art could select and/or combine multiple suitable and/or preferred embodiments in the present invention.

As used herein “DBNPA” is 2,2-dibromo-2-cyanoacetamide, CAS No. 10222-01-2 and glutaraldehyde is pentanedial, CAS No. 111-30-8.

The general method employed in the invention is a conventional froth flotation procedure in which ore is first ground to fine particle size pulp, water is then added to the pulp as required, to create an aqueous pulp, and the pulp is passed to a flotation cell where air is introduced for flotation. Reagents are added to the pulp at the grinding stage, the preflotation conditioning stage, or the flotation stage as required. In the process of the invention, the starting material may be a concentrate from a previous flotation of copper sulfide ore. The process is ordinarily carried out at room temperature and pressure using any kind of water available, although distilled or otherwise treated water may be beneficial in some cases. An exemplary version of a froth floatation process, for illustration purposes, is described in (911 Metallurgist—A Practical Guide to Mineral Processing Engineering https://www.911metallurgist.com/blog/copper-process-flowsheet-example. Accessed on Jul. 12, 2017).

Various metals of value may be present in the ore and subsequent aqueous pulp. Typically metals are present in sulfide form. Such metals of value consist of copper, molybdenum, zinc, gold, nickel, lead, tungsten, and mixtures thereof. A particularly suitable metal of value is copper. According to the present invention metals of value are recovered from the aqueous pulp.

Such metals are then recovered by contacting the aqueous pulp with a biocide. According to the present invention, copper and iron are recovered. Particularly preferred is copper. Such biocides of the present invention are 2,2-dibromo-2-cyanoacetamide, glutaraldehyde, and mixtures thereof. Particularly preferable for the selective recovery of copper in the present invention is 2,2-dibromo-2-cyanoacetamide. According to the present invention, when the metal is copper, productivity of greater than 90%, alternatively greater than 95%, and further alternatively greater than 99% of the copper from the aqueous pulp is realized. Also, when copper and iron are both present, copper will demonstrate the stated productivity, however, the productivity of iron is less than 90%, and further alternatively less than 85%.

Further separation and purification processes may be employed to enable maximum recovery of the metal. Such processes are conventional processes of the art, such as cleaner flotation, which generally increases pH, with an alkaline material like lime, up to 11-12 to liberate and reject silicates and depress pyrite enhancing selective flotation of copper.

### EXAMPLES

### Example 1. Measuring Bacterial Contamination in Copper Mining Process

Eight samples of slurry/water were collected using sterile flasks from different process points at a mining company in Chile (see Table 1). This plant processes raw material consisted of tailings from two different sources. The plant follows a typical extraction process for copper concentrate (911 Metallurgist—A Practical Guide to Mineral Processing Engineering https://www.911metallurgist.com/blog/copper-process-flowsheet-example. Accessed on Jul. 12, 2017) with the exception of having two aforementioned raw material streams processed in parallel through primary, secondary grinding and rougher flotation (after which the streams are combined).

After sampling, water phase was separated from suspended solids by decantation for 10 min and analyzed using the Luminultra ATP QGA test-kit, a 2^{nd} Generation Adenosine Triphosphate (ATP) measurement tool for low-solids water-based samples (ASTM D4012 compliant) (https://www.luminultra.com/qga/). The levels of ATP allow for the estimation of microbe levels in the samples. In addition, the viable counts of microorganisms in the decanted aqueous phase samples were determined using a most probable number (MPN) method in 96-well microtiter plates with serial dilution across the plate using a robotic automated system (Cochran, W. G. Estimation of Bacterial Densities by Means of the “Most Probable Number”. Biometrics, 1950, p. 105-116. Rowe, R., Todd, R., Waide, J. Microtechnique for Most-Probable-Number Analysis. Applied and Environmental Microbiology. 1977, 33, 675-680). Trypticase Soy Broth (TSB) was used as culture media for the MPN method and readings were performed after 48 h incubation at 37° C. Summary of samples and corresponding bacterial levels are summarized in Table 1.

TABLE 1
Samples collected and analyzed for bacterial contamination

| | | | Estimated | Viable |
|---|---|---|---|---|
| | | | Viable | Counts |
| | | Total | counts | from |
| Sample | Sampling point | ATP | from ATP | MPN |
| # | in the process | (pg/mL) | (CFU/mL) | (CFU/ml) |
| 1 | Raw Material 1 | 2087 | 2.1 × 10⁶ | 5 × 10⁵⁻ |
| | | | | 5 × 10⁶ |
| 2 | Raw Material 2 | 2980 | 3.0 × 10⁶ | 5 × 10⁵⁻ |
| | | | | 5 × 10⁶ |
| 3 | Feed of Rougher Flotation | 5830 | 5.8 × 10⁶ | 5 × 10⁵⁻ |
| | (Raw Material 2 stream) | | | 5 × 10⁶ |
| 4 | Tailings of Rougher | 4815 | 4.8 × 10⁶ | 5 × 10⁵⁻ |
| | Flotation | | | 5 × 10⁶ |
| | (Raw Material 1 stream) | | | |
| 5 | Rougher concentrate- | 5749 | 5.7 × 10⁶ | 5 × 10⁵⁻ |
| | combined streams | | | 5 × 10⁶ |
| 6 | Final concentrate-4^{th} | 176 | 1.8 × 10⁵ | 5 × 10⁵⁻ |
| | cleaner | | | 5 × 10⁶ |
| 7 | Water from thickeners | 12165 | 1.2 × 10⁷ | 5 × 10⁵⁻ |
| | | | | 5 × 10⁶ |
| 8 | Fresh water | 169 | 1.7 × 10⁵ | 5 × 10²⁻ |
| | | | | 5 × 10³ |

### Example 2. Evaluating Bacterial Impact on Flotation Process

To evaluate bacterial impact on flotation process, artificially contaminated water was produced and compared to clean tap water. Each water sample from the cited mining company (example 1) was swabbed and streaked on Tryptic Soy Agar (TSA) solid culture media plates and incubated at 37° C. After one week colonies from these plates were transferred to a liquid culture media TSB (Difco) and grown for 72 hours at 37° C. A new streak was done on the solid TSA media obtaining 100% of plate cover after incubation at 37° C. for 48 hours. All the plate surface was scrapped and suspended in a saline solution (4.5%) 3 days before the beginning of flotation trials. 4 mL of bacterial pool (3.4×10⁵ CFU/mL) were added to 5 L of tap water and this was used as contaminated water.

A copper-mine ore (chalcopyrite, CuFeS₂) previously extracted from Raw Material 2 region was crushed and primarily ground. Samples were sieved through Tyler, size 10, mesh using a sieve shaker. About 1 kg of this solid was secondarily ground using 22.23 cm×17.15 cm laboratory ball mill, containing 10 kg of 2.54 cm metal balls at 70 rpm for 30 minutes. The process was carried out in the presence of 500 mL water (tap or contaminated), diesel oil (15 g/ton) and a primary collector from Mathiesen MATCOL D-101 (modified dithiocarbamate) at 38 g/ton to generate a particle size (P80) of 180 μm. The resulting ore pulp was treated with a biocide (Aqucar™ GA 50, Dow Chemical Co. or Aqucar™ DB 20, Dow Chemical Co.), at 100 ppm dosage for 10 minutes (for tap water and contaminated water control samples this step was omitted), and transferred to an Agitair LA-500 Laboratory Flotation Cell filled with water up to 2,700 mL and mixed for two minutes to homogenize, generating a pulp of approximately 31% solids. A secondary collector AX-343 (potassium amyl xanthate plus sodium isobutyl xanthate) was added at 12 g/ton as well as a blend of frothers at 12 g/ton, consisting of 55% methyl isobutyl carbinol (Dow Chemical Co.), 40% Flomin F810 (SNF FloMin, Inc.), 5% Mathiesen DF-1012 (Mathiesen Corp.). Initial pH was maintained at 10.0 via addition of lime and the pulp was conditioned for 20 minutes.

The concentrate was collected by hand scraping the froth from the pulp surface once every 10 seconds for a total flotation time of 12 minutes at 1,440 rpm. Resulting concentrate and the tailings were filtered under vacuum, dried in an oven at 80° C. and analyzed by atomic absorption spectroscopy. Results are presented in table 2. Grade is defined as percentage of the metal on the concentrate and recovery is defined as percentage of the metal in the original feed that is recovered in the concentrate. Productivity for both metals is calculated by multiplication of corresponding grade and recovery values for treated metal divided by the equivalent operation for the tap water sample values (normalized to 100%).

TABLE 2
Metallurgic balance for rougher flotation using
artificially contaminated tap water treated
with organic biocides 10 min before flotation

| | | | | Contaminated |
|---|---|---|---|---|
| | | | Contaminated | Water + |
| | Tap | Contaminated | Water + | 100 ppm |
| | Water | Water | 100 ppm GA | DBNPA |
| Cu Grade, % | 9.19 | 8.10 | 8.32 | 9.49 |
| Cu Recovery, % | 88.3 | 88.3 | 88.0 | 87.2 |
| Cu Productivity | 100% | 88.1% | 90.2% | 102% |
| Fe Grade, % | 19.8 | 15.3 | 17.2 | 17.8 |
| Fe Recovery, % | 46.7 | 43.5 | 44.7 | 43.0 |
| Fe Productivity | 100% | 72.0% | 83.1% | 82.8% |

Treatment with both biocides, glutaraldehyde and DBNPA, showed improvement in copper grade compared to untreated contaminated water samples. DBNPA was the only biocide able to return copper productivity to the level of a tap water, while keeping lower recoveries and grades of the undesirable iron when compared with tap water condition.

1. A process to recover a metal of value from an aqueous pulp, comprising:
i. contacting an aqueous pulp with a biocide, wherein the aqueous pulp comprises a metal ore; and,
ii. thereafter recovering the metal of value by subjecting the aqueous pulp to froth flotation.

2. The process according to claim 1, wherein the biocide is selected from the group consisting of 2,2-dibromo-2-cyanoacetamide, glutaraldehyde, and mixtures thereof.

3. The process according to claim 1, wherein the biocide is 2-dibromo-2-cyanoacetamide.

4. The process according to claim 1, wherein the metal of value is selected from the group consisting of copper, molybdenum, zinc, gold, nickel, lead, tungsten, and mixtures thereof.

5. The process according to claim 4, wherein the metal of value is copper.

6. The process according to claim 5, wherein productivity is greater than 90% for the copper from the aqueous pulp.
